(19) United States
(12) Patent Application Publication
(10) Pub. No.: US 2004/0210612 A1
(43) Pub. Date: Oct. 21, 2004

(54) Numerical calculation method, numerical calculator and numerical calculation program

(75) Inventors: Atsuhiro Tamura, Osaka (JP); Akihiro Ida, Osaka (JP)

Correspondence Address: NIXON PEABODY, LLP, 401 9TH STREET, NW, SUITE 900, WASHINGTON, DC, 20004-2128, US

(73) Assignee: VINAS Co., Ltd., Osaka-shi (JP)

(21) Appl. No.: 10/670,351

(22) Filed: Sep. 26, 2003

(30) Foreign Application Priority Data
Sep. 27, 2002 (JP) 2002-282342

(51) Int. Cl. G06F 7/38

(52) U.S. Cl. 708/446

(57) ABSTRACT

Elements of a vector sequence A·φ^{m} are sampled to be stored in a memory. In this sampling, a combination of spatial sampling and local sampling on the basis of physical phenomenon is employed. A residual minimization coefficient α₁^{m} (wherein l=1, . . . , L) used for obtaining a corrected approximate value φ^{m} is approximately obtained by using elements of a vector sequence A·φ^{k} (wherein k=m−L+1, . . . , m−1) stored in the memory.

### BACKGROUND OF THE INVENTION

The present invention relates to a numerical calculation technique using a computer.

In technique to control a physical quantity such as a pressure or a temperature, successive approximation algorithm has been conventionally used. A residual cutting method is known as highly convergent successive approximation algorithm suitably used for rapidly and accurately obtaining a solution of each parameter to be controlled. Furthermore, Japanese Laid-Open Patent Publication No. 2001-134304 has already described technique to further improve the convergence in the residual cutting method.

In the successive approximation algorithm such as the residual cutting method, the accuracy of a solution is improved by adding a correction quantity to an approximate solution. A sequence of past correction quantities is used for calculating the correction quantity, and the accuracy of the correction quantity can be improved as the sequence is longer. On the other hand, however, as the sequence of past correction quantities is longer, a memory region necessary for the calculation is larger and time required for obtaining the correction quantity is longer.

### SUMMARY OF THE INVENTION

An object of the invention is, in numerical calculation using the successive approximation algorithm, suppressing a memory region necessary for the calculation and shortening calculation time while keeping calculation accuracy.

Specifically, the present invention provides a numerical calculation method, a numerical calculator or a recording medium that stores a numerical calculation program for a physical quantity U by solving A·U=f, wherein A is a coefficient matrix (in N rows by N columns; wherein N is a positive integer) obtained through discrete of a partial differential equation to be satisfied by the physical quantity U, and f is an inhomogeneous term (source term). In the numerical calculation method, the numerical calculator or the recording medium, the processes of setting 0 as an initial value of a number m of repeating times, giving 0 as an initial value of a perturbation quantity 0 and setting (f−A·U⁰) as an initial value r⁰ of a residual r; and repeatedly executing a first step and a second step while incrementing the number m of repeating times until an approximate solution U^{m} is converged, and the first step includes the steps of setting an initial value U⁰ of the physical quantity U; obtaining a predicted approximate value ψ^{m} of A·φ=r^{m} through repeated calculation performed by a first calculation unit including an internal solver, and the second step includes the steps of: obtaining, from the predicted approximate value ψ^{m}, a corrected approximate value φ^{m} for minimizing L² norm of a residual r^{m} through an optimization routine performed by a second calculation unit; and giving (U^{m}+φ^{m}) as an approximate solution U^{m+1} and giving (r^{m}−A·φ^{m}) as a residual r^{m+1}, and in the second step, obtained elements of a vector sequence A·φ^{m} are sampled by a given sampling method to be stored in a memory, and a residual minimization coefficient α₁^{m} (wherein l=1, . . . , L) used for obtaining the corrected approximate value φ^{m} is approximately obtained by using elements of a vector sequence A·φ^{k} (wherein k=m−L+1, . . . , m−1) stored in the memory.

In sampling of elements b₁, b₂, . . . and b_{N} of the vector sequence A·φ^{m} performed in the second step, elements bᵢ (wherein i∈Ω) are preferably selected, whereas a subset Ω is defined as follows:

Ω={i:mod[i,lg]=1}∪{i|fᵢ/a_{ii|>β}}

wherein lg is an integer, β is a real number, fᵢ is an element of the source term and aᵢᵢ is a diagonal term on the ith row in the ith column of the matrix A.

### BRIEF DESCRIPTION OF THE DRAWINGS

FIG. 1 is a flowchart of a numerical calculation method using the residual cutting method;

FIGS. 2A and 2B are conceptual diagrams of sampling of elements of a vector sequence according to an embodiment of the invention;

FIGS. 3A and 3B are diagrams for showing evaluation results of the invention; and

FIG. 4 is a block diagram for conceptually showing the architecture of a numerical calculator of the embodiment.

### DETAILED DESCRIPTION OF THE INVENTION

A preferred embodiment of the invention will now be described with reference to the accompanying drawings.

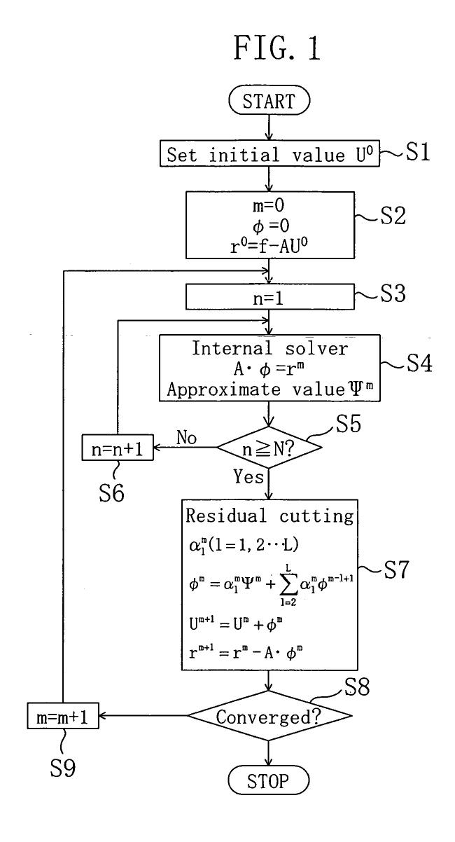

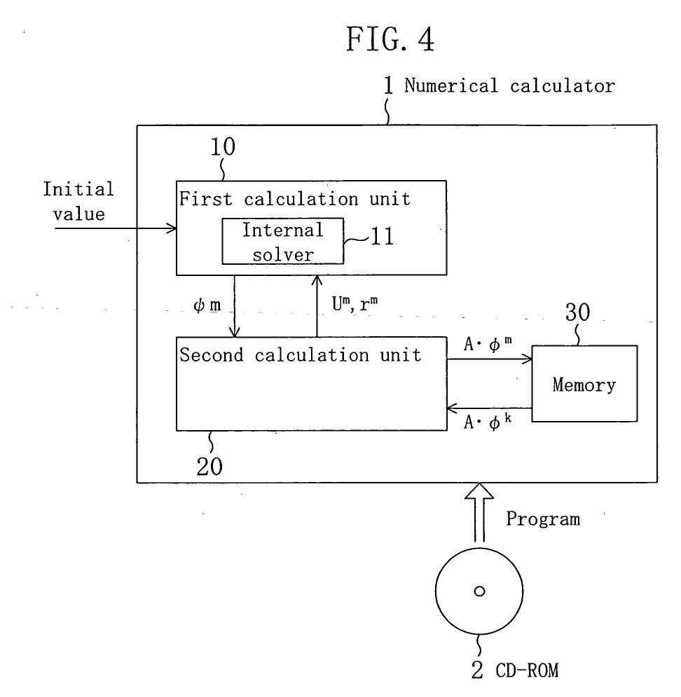

FIG. 1 is a flowchart of a numerical calculation method according to the embodiment of the invention. FIG. 4 is a block diagram for showing the architecture of a numerical calculator 1 according to the embodiment.

(Formulation of Residual Cutting Equation)

It is herein assumed that a physical quantity to be obtained is U, that a coefficient matrix (in N rows by N columns, wherein N is a positive integer) obtained through discrete of a partial differential equation to be satisfied by the physical quantity U is A and that an inhomogeneous term (source term) is f. Under these conditions, an equation to be solved is:

A·U=f (1)

This equation can be generally solved by using successive approximation such as the SOR method or the ADI method.

In the present invention, the following solution method is employed:

A solution U^{∞} of the equation (1) is represented by using an approximate solution U and a perturbation quantity (namely, a difference from a true solution) φ as follows:

U^{∞}=U+φ (2)

In the solution method of this invention, the true solution U^{∞} of the equation (1) is obtained through correction of the approximate solution U by using the obtained perturbation quantity φ.

At this point, a residual r of the approximate solution U is defined as follows:

r=f−A·U (3)

On the basis of the equations (1) through (3), the following is obtained:

$$A \cdot ( U + φ ) = f \\ ∴ A φ = f - A U \\ = r$$

Accordingly, in order to obtain the perturbation quantity φ, the following equation is solved:

Aφ=r (4)

(Algorithm for Residual Cutting Method)

In the algorithm employed in the invention, a convergence solution of the equation (4) is not to be obtained but a predicted approximate value ψ is obtained through a minimum unit of repeated calculations with the steepest convergence gradient by the ADI method or the like, and the thus obtained predicted approximate value ψ is supplied to an optimization control routine. The calculation of the predicted approximate value ψ is repeatedly executed until the result of the optimization control routine satisfies a predetermined condition.

<Optimization Control Routine>

Assuming that the number of repeating times is m, a synthesize perturbation quantity φ^{m} for minimizing the L² norm of the residual and a new approximate solution U^{m+1} are defined as follows:

$${φ}^{m} = {α}_{1}^{m} {ψ}^{m} + {\sum }_{l = 2}^{L} {α}_{l}^{m} {φ}^{m - l + 1} \qquad ( 5 )$$

U^{m+1}=U^{m}+φ^{m} (6)

wherein α₁^{m} (l=1, 2, 3, . . . , L) is a residual minimization coefficient and is a constant obtained through calculation described later. The residual is minimized so as to reduce the L² norm of the residual as follows:

When the new approximate solution U^{m-1} is represented by the equation (6), a residual r^{m+1} of this approximate solution is represented as follows on the basis of the equation (3):

r^{m+1}=f−A·U^{m+1} (7)

When the equation (7) is substituted in the equation (6) and the equations (3) and (5) are used, the following is obtained:

$${r}^{m + 1} = {r}^{m} - {α}_{1}^{m} A \cdot {ψ}^{m} - {\sum }_{l = 2}^{L} {α}_{l}^{m} A \cdot {φ}^{m - l + 1} \qquad ( 8 )$$

The L² norm ∥r^{m+1}∥ of the residual r^{m+1} of the approximate solution U^{m+1} is given by the following equation (9) as a square root of a sum of all points of (r^{m+1})²:

$$‖ {r}^{m + 1} ‖ = \sqrt{( {\sum }_{i}^{N} {( {r}^{m} - {α}_{1}^{m} A \cdot {ψ}^{m} - {\sum }_{l = 2}^{L} {α}_{l}^{m} A \cdot {φ}^{m - l + 1} )}^{2} )} \qquad ( 9 )$$

For minimizing the L² norm ∥r^{m+1}∥ of the residual r^{m+1}, the residual minimization coefficient α₁^{m} (l=1 through L) of the equation (9) is determined by the least square method as follows:

∂/∂α₁^{m}(∥r^{m+1}∥²)=0 l=1, 2, 3, . . . , L (10)

The equations (10) are simultaneous equations of L unknowns with respect to the coefficient α₁^{m}, and when these equations are numerically solved, the coefficient α₁^{m} can be defined. When the coefficient α₁^{m} is defined, the synthesize perturbation quantity φ^{m} is obtained on the basis of the equation (5) and the approximate solution U^{m+1} is obtained on the basis of the equation (6). The calculation method for the residual minimization coefficient α₁^{m} will be described later.

While incrementing the number m, similar routines are repeated, so as to attain convergence of the solution U^{∞} for making zero or minimizing the L² norm of the residual of the equation (9).

Now, the numerical calculation method according to this embodiment will be described with reference to the flowchart shown in FIG. 1. This numerical calculation method can be practiced by allowing a computer to execute a program for realizing this numerical calculation method that is recorded in a recording medium such as a CD-ROM 2.

First, in step S1, an initial value U⁰ of the physical quantity U to be obtained is set. Then, in step S2, 0 (zero) is given as the initial value of the number m of repeating times, 0 (zero) is given as the initial value of the perturbation quantity φ, and the initial value r⁰ of the residual r is set to (f−AU⁰).

Thereafter, procedures of steps S3 through S7 are repeatedly executed with the number m of repeating times incremented until the approximate solution U^{m} is converged.

In steps S3 through S6, an approximate solution (predicted approximate value) ψ^{m} of the following equation is obtained by using a first calculation unit 10 including an internal solver 11 that executes the successive approximation such as the ADI method, the SOR method or the CG method:

A·φ=r^{m}

However, when this equation is to be solved by the existing successive approximation, it is necessary to repeat the calculation too many times for practical use, and hence, the calculation unavoidably takes a massive time. Therefore, in this embodiment, the upper limit N of the number of repeating times of the successive calculation is set (in step S5).

When the predicted approximate value ψ⁰ is obtained through steps S3 through S6, this predicted approximate value ψ⁰ is used, in step S7, for obtaining a corrected approximate value φ⁰ for minimizing a next residual r¹ through the optimization routine executed by a second calculation unit 20. On the basis of the equations (2) and (3), this corrected approximate value φ⁰ is used for obtaining a first-order approximate value U¹ of the physical quantity and a first-order residual r¹ by the following equations:

U¹=U⁰+φ⁰ (12)

r¹=f−AU¹ (13)

When the equation (12) is substituted in the equation (13),

$$\begin{matrix}{r}^{1} = f - A ( {U}^{0} + {φ}^{0} ) \\ = f - A {U}^{0} - A {φ}^{0} \\ = {r}^{0} - A {φ}^{0}\end{matrix} \qquad ( 14 )$$

Thus, the first-order residual r¹ can be obtained by the equation (14).

The number m of repeating times is incremented in step S9, and the flow returns to step S3 for repeating similar calculation. When such procedures are repeated, (U², r²), (U³, r³), . . . (U^{m}, r^{m}), . . . are successively obtained, and the norm ∥r^{m}∥ of the residual is successively reduced.

An equation for obtaining a predicted approximate value ψ^{m} in step S4 when the number of repeating times is m is as follows:

Aφ=r^{m}

Therefore, by using a corrected approximate value φ^{m} optimized through the optimization control routine, the followings are obtained in step S7:

U^{m+1}=U^{m}+φ^{m}

r^{m+1}=r^{m}−Aφ^{m}

(Method for Obtaining Residual Minimization Coefficient α₁)

Herein, δ is introduced as follows for simplification:

δ^{m}=ψ^{m}

δ^{m-1+1}=φ^{m-1+1}, wherein l=2, 3, . . . , L

In this case, the corrected approximate value φ^{m} is represented as follows:

$${φ}^{m} = {\sum }_{l = 1}^{L} {α}_{l}^{m} {δ}^{m - l + 1}$$

Therefore,

$$\begin{matrix}{r}^{m + 1} = {r}^{m} - A {φ}^{m} \\ = {r}^{m} - A {\sum }_{l = 1}^{L} {α}_{l}^{m} {δ}^{m - l + 1} \\ = {r}^{m} - {\sum }_{l = 1}^{L} {α}_{l}^{m} A {δ}^{m - l + 1}\end{matrix}$$

When this equation is expressed without using the symbol Σ,

r^{m+1}=r^{m}−(α₁^{m}Aδ^{m}+α₂^{m}Aδ^{m+1}α₃^{m}Aδ^{m-2}+. . . +α_{L}^{m}Aδ^{m-L+1})

The residual minimization coefficient α₁^{m} can be obtained by using, for example, the least square method employing a condition for minimizing the (m+1)th-order residual norm ∥r^{+m}∥ (a square root of a sum of squares).

$$\begin{matrix}‖ {r}^{m} ‖ = \sqrt{{\sum }_{i}^{N} {( {r}^{m + 1} )}^{2}} \\ {‖ {r}^{m} ‖}^{2} = {\sum }_{i}^{N} {( {r}^{m + 1} )}^{2} \\ = {\sum }_{i}^{N} {( {r}^{m} - {\sum }_{l = 1}^{L} {α}_{l}^{m} A {δ}^{m - l + 1} )}^{2}\end{matrix}$$

When this equation is differentiated with respect to α₁^{m}, the following is obtained:

∂/∂α₁^{m}(||r^{m+1}||²)=0

When this equation is solved with respect to α₁^{m}, the residual minimization coefficient α₁^{m} can be obtained. The differentiation results in the following:

$$\partial / \partial {α}_{l}^{m} ( {‖ {r}^{m + 1} ‖}^{2} ) = 2 {\sum }_{i}^{N} \{ ( {r}^{m} - {\sum }_{l = 1}^{L} {α}_{l}^{m} A {δ}^{m - l + 1} ) \cdot ( - A {δ}^{m - {l}^{′} + 1} ) \} \\ ∴ {\sum }_{i}^{N} ( A {δ}^{m - {l}^{′} + 1} {\sum }_{l = 1}^{L} {α}_{l}^{m} A {δ}^{m - l + 1} ) = {\sum }_{i}^{N} ( {r}^{m} A {δ}^{m - {l}^{′} + 1} )$$

(δ^{m}=ψ^{m}δ^{m-1+1}=φ^{m-1+1}(l=1, 2, 3, . . . , L)

wherein 1′=1, 2, . . . , L. When these linear simultaneous equations are solved, the residual minimization coefficient α₁^{m} can be obtained.

For example, when L=3, the above equations are obtained as ternary linear simultaneous equations as follows:

α₁^{m}Σ(Aψ^{m})²+α₂^{m}Σ(A_{ψ}^{m}Aφ^{m-1})+α₃^{m}Σ(Aψ^{m}Aφ^{m-2})=Σ(r^{m}A_{ψ}^{m})

α₁^{m}Σ(Aφ^{m-1}Aψ^{m})+α₂^{m}Σ(Aφ^{m-1})²+α₃^{m}Σ(Aφ^{m-1}Aφ^{m-2})=Σ(r^{m}Aφ^{m-1})

α₁^{m}Σ(Aφ^{m-2}Aψ^{m})+α₂^{m}Σ(Aφ^{m-2}Aφ^{m-1)+α}₃^{m}Σ(Aφ^{m-2})²=Σ(r^{m}Aφ^{m-2})

Therefore,

φ^{m}=α₁^{m}ψ^{m}+α₂^{m}φ^{m-1}+α₃^{m}φ^{m-2}

$${r}^{m + 1} = {r}^{m} - ( {α}_{1}^{m} A {ψ}^{m} + {α}_{2}^{m} A {φ}^{m - 1} + {α}_{3}^{m} A {φ}^{m - 2} ) \\ = {r}^{m} - A {φ}^{m}$$

$${U}^{m + 1} = {U}^{m} + {φ}^{m}$$

<Sampling of Vector Sequence>

As described above, it is necessary to solve the aforementioned linear simultaneous equations to obtain the residual minimization coefficient α₁^{m}. In these equations, a vector sequence of A·φ^{m-1}, A·φ^{m-2}, etc. appears frequently. Therefore, in this embodiment, the obtained elements of the vector sequence A·φ^{m} are stored in a memory 30 in step S7. Thus, the residual minimization coefficient α₁^{m} (l=1, . . . , L) to be used for obtaining the corrected approximate value φ^{m} can be obtained by using the elements of the vector sequence A·φ^{k} (k=m−L+1, . . . , m−1) already stored in the memory 30, and hence, the efficiency in the calculation can be improved.

Furthermore, in this embodiment, a method for storing the vector sequence A·φ^{m} devised to save the memory capacity and the calculation time will be proposed. Specifically, not all the elements b₁, b₂, . . . , and b_{N} of the vector sequence A·φ^{m} are stored in the memory 30 but part of the elements are sampled to be stored.

At this point, a subset Ω of a set {1, 2, . . . , N} is defined as follows:

Ω={i:mod[i,lg]=1}∪{i:|fᵢ/aᵢᵢ|>β}

wherein lg is an integer parameter, β is a real parameter, as is an element on the ith row in the ith column, namely, a diagonal term, of the matrix A, fᵢ is an element of the source term f. When lg=1 or β=0, Ω{1, 2, . . . , N}. In storing the elements of the vector sequence A·φ^{m}, not all the elements b₁, b₂, . . . , and b_{N} are stored but merely elements whose row numbers i are contained in the subset Ω, namely, merely elements bi (i c Q), are selected to be stored. In other words, the aforementioned inner product calculation is approximately performed by using a sum of the sampled elements alone.

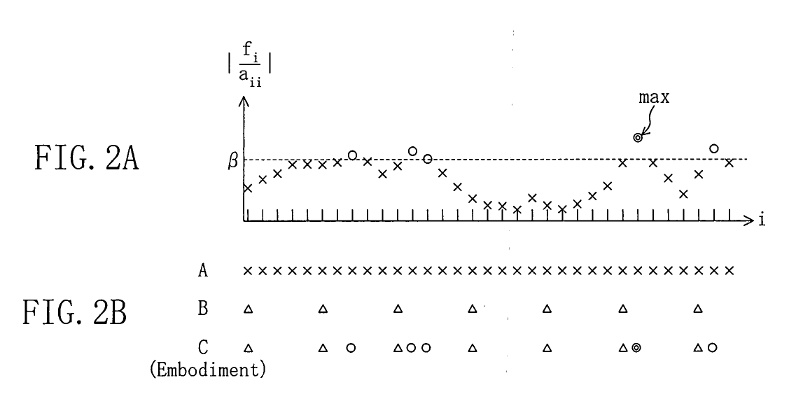

FIGS. 2A and 2B are diagrams for conceptually showing exemplified sampling of the elements of the vector sequence A·φ^{m}. FIG. 2A is a graph for showing the distribution of the respective elements fᵢ of the source term f, which is normalized by the diagonal term aᵢᵢ of the matrix A. FIG. 2B shows the exemplified sampling performed on the distribution shown in FIG. 2A, wherein an example A shows a sequence obtained when all the elements are selected, an example B shows a sequence obtained when elements at predetermined intervals (every five elements) are selected, and an example C shows a sequence obtained when the elements belonging to the subset Ω are selected as in this embodiment. Herein, the value of the real parameter β is set on the basis of the maximum value of |fᵢ/aᵢᵢ|, and β=0.98 max (|fᵢ/aᵢᵢ|).

As is understood from FIGS. 2A and 2B, when the elements belonging to the subset Ω are selected as in this embodiment (namely, in the example C), sampled elements are obtained as a combination of spatially uniformly sampled elements (shown with a symbol Δ) and so-called locally sampled elements on the basis of the characteristic of the physical phenomenon (shown with symbols ◯ and ⊚). It goes without saying that the sampling method is not limited to that described herein but spatial sampling similar to the example B alone may be employed or local sampling on the basis of the physical phenomenon alone may be employed. For example, the subset Ω may be defined as follows:

Ω={i:mod[i,lg]=1} or

Ω={i:|fᵢ/aᵢᵢ|>β}

However, in order to save the memory capacity and shorten the calculation time while keeping the calculation accuracy, the combination of the spatial sampling and the local sampling on the basis of the physical phenomenon is preferably employed.

<Evaluation of the Invention>

In order to evaluate the effect of the invention, numerical calculation of common equations is actually executed on a computer by the residual cutting method separately in the case where the sampling is not performed (referred to as the case 1) and in the case where the sampling is performed by using the above-described subset Ω (referred to as the case 2). In this evaluation, the equations to be solved are linear simultaneous equations obtained through discrete of the Poisson's equation on a three-dimensional lattice by using a secondary accuracy difference, the SOR method is employed in the internal solver 11, and the number of the residual minimization coefficients α₁^{m} is 15 (L=15). Also, lg=7, β=0.98 max (|fᵢ/aᵢᵢ|).

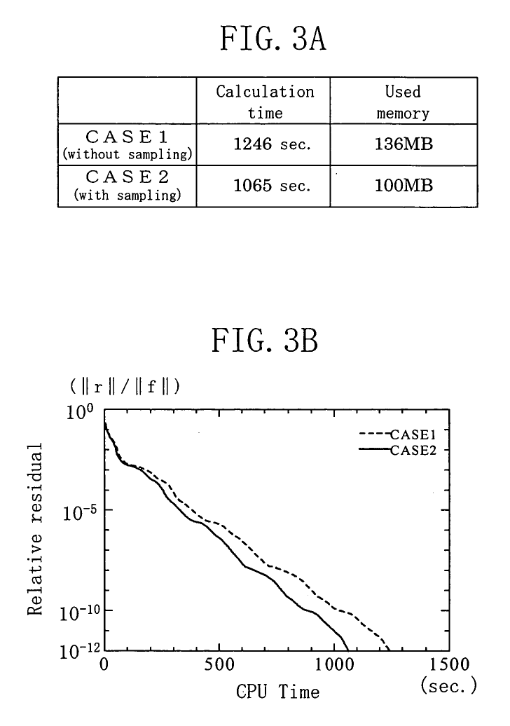

FIGS. 3A and 3B show the evaluation results. In FIG. 3B, the ordinate indicates the relative residual ∥r∥/∥f∥, and the abscissa indicates CPU time. It is understood from FIGS. 3A and 3B that when the sampling according to this embodiment is employed, the calculation time is shortened by approximately 15% and the used memory capacity is reduced by approximately 25% as compared with the case where the sampling is not performed.

The numerical calculation herein described is usable in a variety of fields. For example, it is applicable to analysis technology such as fluid analysis as well as to control technology such as driving control for a vehicle.

As described so far, according to this invention, the residual minimization coefficient α₁^{m} (l=1, . . . , L) to be used for obtaining the corrected approximate value φ^{m} can be approximately obtained by using the elements of the vector sequence A·φ^{k} (k=m−L+1, . . . , m−1) stored in the memory, and hence, the efficiency in the calculation can be improved. In addition, the elements of the vector sequence A·φ^{k} are sampled to be stored in the memory, the memory capacity necessary for the calculation can be suppressed and the calculation time can be shortened.

What is claimed is:

1. A numerical calculation method for a physical quantity U practiced on a computer by solving A·U=f, wherein A is a coefficient matrix (in N rows by N columns; wherein N is a positive integer) obtained through discrete of a partial differential equation to be satisfied by said physical quantity U, and f is an inhomogeneous term (source term), comprising the processes of:
setting an initial value U⁰ of said physical quantity U;
setting 0 as an initial value of a number m of repeating times, giving 0 as an initial value of a perturbation quantity φ and setting (f−A·U⁰) as an initial value r⁰ of a residual r; and
repeatedly executing a first step and a second step while incrementing said number m of repeating times until an approximate solution U^{m} is converged,
wherein said first step includes the steps of:
obtaining a predicted approximate value ψ^{m} of A·φ=r^{m} through repeated calculation performed by a first calculation unit including an internal solver, and
said second step includes the steps of:
obtaining, from said predicted approximate value ψ^{m}, a corrected approximate value φ^{m} for minimizing L² norm of a residual r^{m} through an optimization routine performed by a second calculation unit; and
giving (U^{m}+φ^{m}) as an approximate solution U^{m+1} and giving (r^{m}−A·φ^{m}) as a residual r^{m+1},
wherein in said second step, obtained elements of a vector sequence A·φ^{m} are sampled by a given sampling method to be stored in a memory, and
a residual minimization coefficient α₁^{m} (wherein l=1, . . . , L) used for obtaining said corrected approximate value φ^{m} is approximately obtained by using elements of a vector sequence A·φ^{k} (wherein k=m−L+m−1) stored in said memory.

2. The numerical calculation method of claim 1,
wherein in sampling of elements b₁, b₂, . . . and b_{N} of said vector sequence A·φ^{m} performed in said second step, elements bᵢ (wherein i∈Ω) are selected, whereas a subset Ω is defined as follows:
Ω={i:mod[i,lg]=1}∪{i:|fᵢ/aᵢᵢ|>β}
wherein lg is an integer, β is a real number, fᵢ is an element of said source term and aᵢᵢ is a diagonal term on the ith row in the ith column of said matrix A.

3. A numerical calculator for a physical quantity U by solving A·U=f, wherein A is a coefficient matrix (in N rows by N columns; wherein N is a positive integer) obtained through discrete of a partial differential equation to be satisfied by said physical quantity U, and f is an inhomogeneous term (source term), performing the processes of:
setting an initial value U⁰ of said physical quantity U;
setting 0 as an initial value of a number m of repeating times, giving 0 as an initial value of a perturbation quantity φ and setting (f−A·U⁰) as an initial value r⁰ of a residual r; and
repeatedly executing a first step and a second step while incrementing said number m of repeating times until an approximate solution U^{m} is converged,
wherein said first step includes the steps of:
obtaining a predicted approximate value ψ^{m} of A·φ=r^{m} through repeated calculation performed by a first calculation unit including an internal solver, and
said second step includes the steps of:
obtaining, from said predicted approximate value ψ^{m}, a corrected approximate value ψ^{m} for minimizing L² norm of a residual r^{m} through an optimization routine performed by a second calculation unit; and
giving (U^{m}+φ^{m}) as an approximate solution U^{m+1} and giving (r^{m}−A·φ^{m}) as a residual r^{m+1},
wherein in said second step, obtained elements of a vector sequence A·φ^{m} are sampled by a given sampling method to be stored in a memory, and
a residual minimization coefficient α₁^{m} (wherein l=1, . . . , L) used for obtaining said corrected approximate value φ^{m} is approximately obtained by using elements of a vector sequence A·φ^{k} (wherein k=m−L+1, . . . , m−1) stored in said memory.

4. The numerical calculator of claim 3,
wherein in sampling of elements b₁, b₂, . . . and b_{N} of said vector sequence A·φ^{m} performed in said second step, elements bᵢ (wherein i∈Ω) are selected, whereas a subset Ω is defined as follows:
Ω={i:mod[i,lg]=1}U {i:|fᵢ/aᵢᵢ|>β}
wherein lg is an integer, β is a real number, fᵢ is an element of said source term and aᵢᵢ is a diagonal term on the ith row in the ith column of said matrix A.

5. A recording medium that stores a numerical calculation program for a physical quantity U by allowing a computer to solve A·U=f, wherein A is a coefficient matrix (in N rows by N columns; wherein N is a positive integer) obtained through discrete of a partial differential equation to be satisfied by said physical quantity U, and f is an inhomogeneous term (source term),
wherein said numerical calculation program makes said computer to execute the processes of:
setting an initial value U⁰ of said physical quantity U;
setting 0 as an initial value of a number m of repeating times, giving 0 as an initial value of a perturbation quantity φ and setting (f−A·U⁰) as an initial value r⁰ of a residual r; and
repeatedly executing a first step and a second step while incrementing said number m of repeating times until an approximate solution U^{m} is converged,
wherein said first step includes the steps of:
obtaining a predicted approximate value ψ^{m} of A·φ=r^{m} through repeated calculation performed by a first calculation unit including an internal solver, and
said second step includes the steps of:
obtaining, from said predicted approximate value ψ^{m}, a corrected approximate value φ^{m} for minimizing L² norm of a residual r^{m} through an optimization routine performed by a second calculation unit; and
giving (U^{m}+φ^{m}) as an approximate solution U^{m+1} and giving (r^{m}−A·φ^{m}) as a residual r^{m+1},
wherein in said second step, obtained elements of a vector sequence A·φ^{m} are sampled by a given sampling method to be stored in a memory, and
a residual minimization coefficient α₁^{m} (wherein l=1, . . . , L) used for obtaining said corrected approximate value φ^{m} is approximately obtained by using elements of a vector sequence A·φ^{k} (wherein k=m−L+1, . . . , m−1) stored in said memory.

6. The recording medium of claim 5,
wherein in sampling of elements b₁, b₂, . . . and b_{N} of said vector sequence A·φ^{m} performed in said second step, elements bᵢ (wherein i∈Ω) are selected, whereas a subset Ω is defined as follows:
Ω={i:mod[i,lg]=1}∪{i:|fᵢ/aᵢᵢ|>β}
wherein lg is an integer, β is a real number, fᵢ is an element of said source term and aᵢᵢ is a diagonal term on the ith row in the ith column of said matrix A.
